(19) United States
(12) Patent Application Publication
(10) Pub. No.: US 2026/0229032 A1
(43) Pub. Date: Aug. 6, 2026

(54) AUGMENTED REALITY AI RANGEFINDER ASSISTED 3D IMAGE DISPLAY SYSTEMS AND METHODS

(71) Applicant: Teledyne FLIR Defense, Inc., Thousand Oaks, CA (US)

(72) Inventor: Christopher A. Schera, Merrimack, NH (US)

(21) Appl. No.: 19/530,203

(22) Filed: Feb. 4, 2026

Related U.S. Application Data
(60) Provisional application No. 63/754,501, filed on Feb. 5, 2025.

(51) Int. Cl. G06V 20/20; G01C 3/08; G06V 10/74; G06V 10/82

(52) U.S. Cl. CPC G06V 20/20; G01C 3/08; G06V 10/761; G06V 10/82

(57) ABSTRACT

Techniques are provided for an artificial intelligence system that uses one or more neural network models to identify objects in image frames and the distances of the objects from the imaging device. Techniques are also provided for generating and displaying augmented three-dimensional images that include the objects at depths based on the distances. For example, the artificial intelligence system receives an image frame and uses one or more neural network models to identify objects in the image frame. Next, the one or more neural network models identify distances corresponding to the objects based on the sizes of the objects in the image frame. The artificial intelligence system also generates an augmented image by augmenting the objects in the image frame based on the object type and/or distances. The augmented images are rendered as three-dimensional images that display the objects at various depths based on the distances.

### CROSS REFERENCE TO RELATED APPLICATIONS

This application claims priority to and the benefit of U.S. Provisional Patent Application No. 63/754,501 filed Feb. 5, 2025 and entitled “AUGMENTED REALITY AI RANGEFINDER ASSISTED 3D IMAGE DISPLAY SYSTEMS AND METHODS,” which is incorporated herein by reference in its entirety.

### TECHNICAL FIELD

The present invention relates generally to image processing and, more particularly, to using artificial intelligence systems to identify distances of objects from an image frame and generating an augmented three-dimensional image based on the objects and the distances.

### BACKGROUND

Various types of imaging devices are used to capture image frames (e.g., images) in response to electromagnetic radiation received from scenes of interest. These images may be displayed on a display. However, from the images, it may be difficult to identify distances of objects in the image frames. Accordingly, the embodiments are directed to an artificial intelligence system that identifies objects and distances of these objects from imaging devices. Further, the embodiments are directed to generating augmented three-dimensional images that include the objects and depths of the objects based on the distances.

### SUMMARY

Methods and systems are provided for an artificial intelligence system that uses one or more neural network models to identify objects in image frames and determine the distances of the objects from the imaging device. Methods and systems are further provided for generating and displaying augmented three-dimensional images that include the objects at depths based on the distances.

In one embodiment, a method includes receiving an image frame, identifying, using one or more neural network models, one or more objects in the image frame, identifying, using the one or more neural network models, one or more distances corresponding to the one or more objects based on the corresponding sizes of the objects in the image frame, generating an augmented image based on the objects and/or the distances, and displaying a three-dimensional representation of the augmented image.

The embodiments are further directed to a method where the image frame is generated by a bi-ocular thermal imager and the image frame includes a thermal image.

The embodiments are further directed to a method where the augmented image includes highlights that encircle the objects.

The embodiments are further directed to a method where the colors of the highlights correspond to the types of the objects.

The embodiments are further directed to a method where the colors of the highlights correspond to the confidence levels for identifying the distances for the corresponding objects.

The embodiments are further directed to a method where the displayed three-dimensional augmented image shows the depths of the objects based on the distances.

The embodiments are further directed to a method that includes determining an object among the objects for which the neural networks failed to identify a distance, receiving input from a range finder that corresponds to the distance, and regenerating the three-dimensional representation of the augmented image to include the object based on the received distance.

The embodiments are further directed to a method that includes receiving input to deselect an object from the displayed three-dimensional augmented image and regenerating the three-dimensional representation of the augmented image without the object.

In another embodiment, a system includes a logic device configured to execute an artificial intelligence system comprising one or more neural network models and configured to receive an image frame, identify, using one or more neural network models, one or more objects in the image frame, identify, using the neural network models, one or more distances corresponding to the objects based on the corresponding sizes of the objects in the image frame, generate an augmented image based on the objects and/or the distances, and display a three-dimensional representation of the augmented image.

In another embodiment, a non-transitory computer-readable medium has instructions stored thereon that, when executed by a processor, cause the processor to perform operations including receiving an image frame, identifying, using one or more neural network models, one or more objects in the image frame, identifying, using the neural network models, one or more distances corresponding to the objects based on the corresponding sizes of the objects in the image frame, generating an augmented image based on the objects and/or the distances, and displaying a three-dimensional representation of the augmented image.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an imaging system in accordance with an embodiment of the disclosure.

FIG. 2 illustrates a block diagram of an image capture component in accordance with an embodiment of the disclosure.

FIG. 3 illustrates a block diagram of an artificial intelligence system for generating an augmented image, in accordance with an embodiment of the disclosure.

FIGS. 4A-B illustrate example augmented images with objects, in accordance with an embodiment of the disclosure.

FIG. 5 illustrates a process for displaying a three-dimensional augmented image, in accordance with an embodiment of the disclosure.

FIG. 6 illustrates a neural network model in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

The embodiments are directed to an imaging system. The imaging system may receive image frames from an imaging device, such as a thermal imaging device that generates thermal image frames of an environment. The thermal imaging device may be a bi-ocular thermal imaging device. The imaging system includes an artificial intelligence system that incorporates one or more neural network models trained to identify objects in the image frames and determine the distances of the objects from the thermal imaging device. In some instances, the one or more neural networks may be convolutional neural networks that are trained to classify the objects in the image frames into various object types, e.g., a human, a car, a cell tower, a house, and the like. The one or more neural network models may then determine the distance of each object based on the size of the object in the image frames.

The AI system may also augment the objects in the image frames. The augmentation may be a highlight, an encircling of the object, and the like. The color of the augmentation of each object may correspond to an object type or to a confidence level in identifying the distance of the object from the imaging device.

The imaging system may also display a three-dimensional representation of the augmented image. The three-dimensional representation may include objects that are highlighted, encircled, etc., using one or more colors. Further, the depth of the objects in the three-dimensional representation of the augmented image may be based on the distances determined by the AI system. Further description of the embodiments is discussed below.

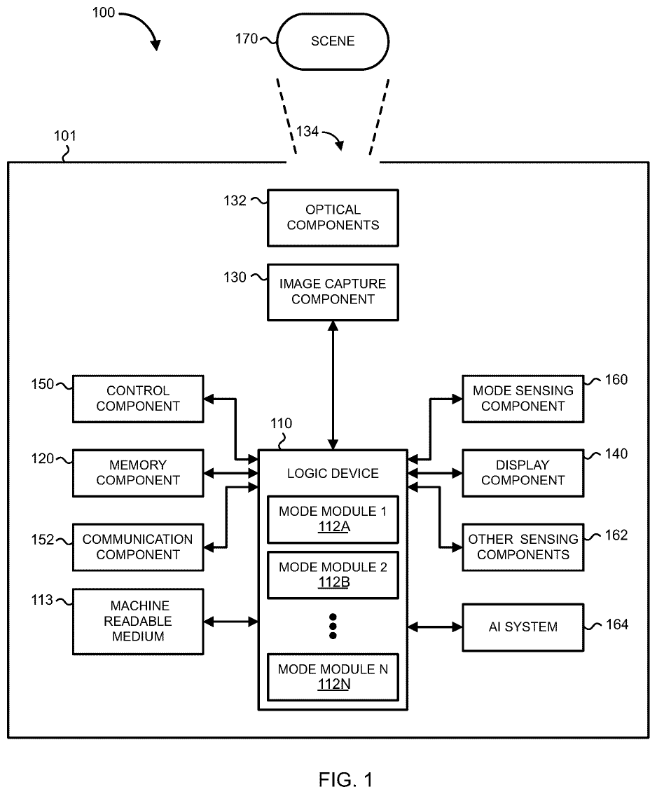

Turning now to the drawings, FIG. 1 illustrates a block diagram of an imaging system 100 in accordance with an embodiment of the disclosure. Imaging system 100 may be used to capture and process image frames in accordance with various techniques described herein. In one embodiment, various components of imaging system 100 may be provided in a housing 101, such as a housing of a camera, a personal electronic device (e.g., a mobile phone), or other system. In another embodiment, one or more components of imaging system 100 may be implemented remotely from each other in a distributed fashion (e.g., networked or otherwise).

In one embodiment, imaging system 100 includes a logic device 110, a memory component 120, an image capture component 130, optical components 132 (e.g., one or more lenses configured to receive electromagnetic radiation through an aperture 134 in housing 101 and pass the electromagnetic radiation to image capture component 130), a display component 140, a control component 150, a communication component 152, a mode sensing component 160, and a sensing component 162.

In various embodiments, imaging system 100 may implemented as an imaging device, such as a camera, to capture image frames, for example, of a scene 170 (e.g., a field of view) in an external environment (e.g., external to imaging system 100). Imaging system 100 may represent any type of camera system which, for example, detects electromagnetic radiation (e.g., irradiance) and provides representative data (e.g., one or more still image frames or video image frames). For example, imaging system 100 may represent a camera that is directed to detect one or more ranges (e.g., wavebands) of electromagnetic radiation and provide associated image data. In some embodiments, imaging system 100 may include a portable device. In some embodiments, imaging system 100 may be implemented as a handheld device, including a thermal imager handheld device. In some embodiments, imaging system 100 may be a non-portable and/or non-handheld device. In some embodiments, imaging system 100 may be attached to a gimbal and/or other mechanism, device, or structure. In some embodiments, imaging system 100 may be coupled to various types of vehicles (e.g., a land-based vehicle, a watercraft, an aircraft, a spacecraft, or other vehicle) or to various types of fixed locations (e.g., a home security mount, a campsite or outdoors mount, or other location) via one or more types of mounts. In still another embodiment, imaging system 100 may be integrated as part of a non-mobile installation to provide image frames to be stored and/or displayed.

Logic device 110 may include, for example, a microprocessor, a single-core processor, a multi-core processor, a microcontroller, a programmable logic device (e.g., a field programmable logic device (FPGA)), and/or other device configured to perform processing operations, a digital signal processing (DSP) device, one or more memories for storing executable instructions (e.g., software, firmware, or other instructions), and/or or any other appropriate combination of processing device and/or memory to execute instructions to perform any of the various operations described herein. Logic device 110 is adapted to interface and communicate with components 120, 130, 140, 150, 160, 162, and 164 to perform method and processing steps as described herein. Logic device 110 may include one or more mode modules 112A-112N for operating in one or more modes of operation (e.g., to operate in accordance with any of the various embodiments disclosed herein). In one embodiment, mode modules 112A-112N are adapted to define processing and/or display operations that may be embedded in logic device 110 or stored on memory component 120 for access and execution by logic device 110. In another aspect, logic device 110 may be adapted to perform various types of image processing techniques as described herein.

In various embodiments, it should be appreciated that each mode module 112A-112N may be integrated in software and/or hardware as part of logic device 110, or code (e.g., software or configuration data) for each mode of operation associated with each mode module 112A-112N, which may be stored in memory component 120. Embodiments of mode modules 112A-112N (i.e., modes of operation) disclosed herein may be stored by a machine readable medium 113 in a non-transitory manner (e.g., a memory, a hard drive, a compact disk, a digital video disk, or a flash memory) to be executed by a computer (e.g., logic or processor-based system) to perform various methods disclosed herein.

In various embodiments, the machine readable medium 113 may be included as part of imaging system 100 and/or separate from imaging system 100, with stored mode modules 112A-112N provided to imaging system 100 by coupling the machine readable medium 113 to imaging system 100 and/or by imaging system 100 downloading (e.g., via a wired or wireless link) the mode modules 112A-112N from the machine readable medium (e.g., containing the non-transitory information). In various embodiments, as described herein, mode modules 112A-112N provide for improved camera processing techniques for real time applications, wherein a user or operator may change the mode of operation depending on a particular application, such as an off-road application, a maritime application, an aircraft application, a space application, or other application.

Memory component 120 includes, in one embodiment, one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, or other types of memory. In one embodiment, logic device 110 is adapted to execute software stored in memory component 120 and/or machine readable medium 113 to perform various methods, processes, and modes of operations in manner as described herein.

In some embodiments, image capture component 130 includes one or more sensors (e.g., any type of thermal infrared, near infrared, short wave infrared, mid wave infrared, long wave infrared, visible light, and/or other type of detector, including a detector implemented as part of a focal plane array) responsive to radiation received from scene 170. For example, the sensors of image capture component 130 may store voltages in response to radiation received from scene 170 (e.g., by integrating currents responsive to the radiation) and convert the voltages (e.g., via an analog-to-digital converter and/or other circuitry included as part of the sensor or separate from the sensor as part of imaging system 100) to pixel counts associated with pixels of the image frames.

Logic device 110 may be adapted to receive image frames from image capture component 130, process image frames, store image frames in memory component 120, and/or retrieve stored image frames from memory component 120. Logic device 110 may be adapted to process image frames stored in memory component 120 to provide image frames to display component 140 for viewing by a user.

Display component 140 includes, in one embodiment, an image display device (e.g., a liquid crystal display (LCD)) or various other types of generally known video displays or monitors. Logic device 110 may be adapted to display image data and information on display component 140. Logic device 110 may be adapted to retrieve image data and information from memory component 120 and display any retrieved image data and information on display component 140. Display component 140 may include display electronics, which may be utilized by logic device 110 to display image data and information. Display component 140 may receive image data and information directly from image capture component 130 via logic device 110, or the image data and information may be transferred from memory component 120 via logic device 110.

In one embodiment, logic device 110 may initially process a captured thermal image frame and present a processed image frame in one mode, corresponding to mode modules 112A-112N, and then upon user input to control component 150, logic device 110 may switch the current mode to a different mode for viewing the processed image frame on display component 140 in the different mode. This switching may be referred to as applying the camera processing techniques of mode modules 112A-112N for real time applications, wherein a user or operator may change the mode while viewing an image frame on display component 140 based on user input to control component 150. In various aspects, display component 140 may be remotely positioned, and logic device 110 may be adapted to remotely display image data and information on display component 140 via wired or wireless communication with display component 140, as described herein.

Control component 150 includes, in one embodiment, a user input and/or interface device having one or more user actuated components, such as one or more push buttons, slide bars, rotatable knobs or a keyboard, that are adapted to generate one or more user actuated input control signals. Control component 150 may be adapted to be integrated as part of display component 140 to operate as both a user input device and a display device, such as, for example, a touch screen device adapted to receive input signals from a user touching different parts of the display screen. Logic device 110 may be adapted to sense control input signals from control component 150 and respond to any sensed control input signals received therefrom.

Control component 150 may include, in one embodiment, a control panel unit (e.g., a wired or wireless handheld control unit) having one or more user-activated mechanisms (e.g., buttons, knobs, sliders, or others) adapted to interface with a user and receive user input control signals. In various embodiments, the one or more user-activated mechanisms of the control panel unit may be utilized to select between the various modes of operation, as described herein in reference to mode modules 112A-112N. In other embodiments, it should be appreciated that the control panel unit may be adapted to include one or more other user-activated mechanisms to provide various other control operations of imaging system 100, such as auto-focus, menu enable and selection, field of view (FoV), brightness, contrast, gain, offset, spatial, temporal, and/or various other features and/or parameters. In still other embodiments, a variable gain signal may be adjusted by the user or operator based on a selected mode of operation.

In another embodiment, control component 150 may include a graphical user interface (GUI), which may be integrated as part of display component 140 (e.g., a user actuated touch screen), having one or more images of the user-activated mechanisms (e.g., buttons, knobs, sliders, or others), which are adapted to interface with a user and receive user input control signals via the display component 140. As an example for one or more embodiments as discussed further herein, display component 140 and control component 150 may represent appropriate portions of a smart phone, a tablet, a personal digital assistant (e.g., a wireless, mobile device), a laptop computer, a desktop computer, or other type of device.

Mode sensing component 160 includes, in one embodiment, an application sensor adapted to automatically sense a mode of operation, depending on the sensed application (e.g., intended use or implementation), and provide related information to logic device 110. In various embodiments, the application sensor may include a mechanical triggering mechanism (e.g., a clamp, clip, hook, switch, push-button, or others), an electronic triggering mechanism (e.g., an electronic switch, push-button, electrical signal, electrical connection, or others), an electro-mechanical triggering mechanism, an electro-magnetic triggering mechanism, or some combination thereof. For example, for one or more embodiments, mode sensing component 160 senses a mode of operation corresponding to the intended application of imaging system 100 based on the type of mount (e.g., accessory or fixture) to which a user has coupled the imaging system 100 (e.g., image capture component 130). Alternatively, the mode of operation may be provided via control component 150 by a user of imaging system 100 (e.g., wirelessly via display component 140 having a touch screen or other user input representing control component 150).

Furthermore, in accordance with one or more embodiments, a default mode of operation may be provided, such as for example when mode sensing component 160 does not sense a particular mode of operation (e.g., no mount sensed or user selection provided). For example, imaging system 100 may be used in a freeform mode (e.g., handheld with no mount) and the default mode of operation may be set to handheld operation, with the image frames provided wirelessly to a wireless display (e.g., another handheld device with a display, such as a smart phone, or to a vehicle's display).

Mode sensing component 160, in one embodiment, may include a mechanical locking mechanism adapted to secure the imaging system 100 to a vehicle or part thereof and may include a sensor adapted to provide a sensing signal to logic device 110 when the imaging system 100 is mounted and/or secured to the vehicle. Mode sensing component 160, in one embodiment, may be adapted to receive an electrical signal and/or sense an electrical connection type and/or mechanical mount type and provide a sensing signal to logic device 110. Alternatively or in addition, as discussed herein for one or more embodiments, a user may provide a user input via control component 150 (e.g., a wireless touch screen of display component 140) to designate the desired mode (e.g., application) of imaging system 100.

Logic device 110 may be adapted to communicate with mode sensing component 160 (e.g., by receiving sensor information from mode sensing component 160) and image capture component 130 (e.g., by receiving data and information from image capture component 130 and providing and/or receiving command, control, and/or other information to and/or from other components of imaging system 100).

In various embodiments, mode sensing component 160 may be adapted to provide data and information relating to system applications including a handheld implementation and/or coupling implementation associated with various types of vehicles (e.g., a land-based vehicle, a watercraft, an aircraft, a spacecraft, or other vehicle) or stationary applications (e.g., a fixed location, such as on a structure). In one embodiment, mode sensing component 160 may include communication devices that relay information to logic device 110 via wireless communication. For example, mode sensing component 160 may be adapted to receive and/or provide information through a satellite, through a local broadcast transmission (e.g., radio frequency), through a mobile or cellular network and/or through information beacons in an infrastructure (e.g., a transportation or highway information beacon infrastructure) or various other wired or wireless techniques (e.g., using various local area or wide area wireless standards).

In another embodiment, imaging system 100 may include one or more other types of sensing components 162, including environmental and/or operational sensors, depending on the sensed application or implementation, which provide information to logic device 110 (e.g., by receiving sensor information from each sensing component 162). In various embodiments, other sensing components 162 may be adapted to provide data and information related to environmental conditions, such as internal and/or external temperature conditions, lighting conditions (e.g., day, night, dusk, and/or dawn), humidity levels, specific weather conditions (e.g., sun, rain, and/or snow), distance (e.g., laser rangefinder), and/or whether a tunnel, a covered parking garage, or that some type of enclosure has been entered or exited. Accordingly, other sensing components 162 may include one or more conventional sensors as would be known by those skilled in the art for monitoring various conditions (e.g., environmental conditions) that may have an effect (e.g., on the image appearance) on the data provided by image capture component 130.

In some embodiments, other sensing components 162 may include devices that relay information to logic device 110 via wireless communication. For example, each sensing component 162 may be adapted to receive information from a satellite, through a local broadcast (e.g., radio frequency) transmission, through a mobile or cellular network and/or through information beacons in an infrastructure (e.g., a transportation or highway information beacon infrastructure) or various other wired or wireless techniques. In some embodiments, other sensing components 162 may include one or more motion and/or location sensors (e.g., accelerometers, gyroscopes, micro-electromechanical system (MEMS) devices, and/or others as appropriate).

In various embodiments, components of imaging system 100 may be combined and/or implemented or not, as desired or depending on application requirements, with imaging system 100 representing various operational blocks of a system. For example, logic device 110 may be combined with memory component 120, image capture component 130, display component 140, and/or mode sensing component 160. In another example, logic device 110 may be combined with image capture component 130 with only certain operations of logic device 110 performed by circuitry (e.g., a processor, a microprocessor, a microcontroller, a logic device, or other circuitry) within image capture component 130. In still another example, control component 150 may be combined with one or more other components or be remotely connected to at least one other component, such as logic device 110, via a wired or wireless control device so as to provide control signals thereto.

In some embodiments, communication component 152 may be implemented as a network interface component (NIC) adapted for communication with a network including other devices in the network. In various embodiments, communication component 152 may include a wireless communication component, such as a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components adapted for communication with a network. As such, communication component 152 may include an antenna coupled thereto for wireless communication purposes. In other embodiments, the communication component 152 may be adapted to interface with a DSL (e.g., Digital Subscriber Line) modem, a PSTN (Public Switched Telephone Network) modem, an Ethernet device, and/or various other types of wired and/or wireless network communication devices adapted for communication with a network.

In some embodiments, AI system 164 may receive image frames from image capture component 130. AI system 164 may identify and highlight objects in one or more image frames, such as people cars, cell towers, and the like. AI system 164 may also estimate a distance of the objects based on the feature size from the image capture component 130. AI system 164 may also mark objects for which AI system 164 is unable to determine the distance or objects that AI system 164 is unable to identify.

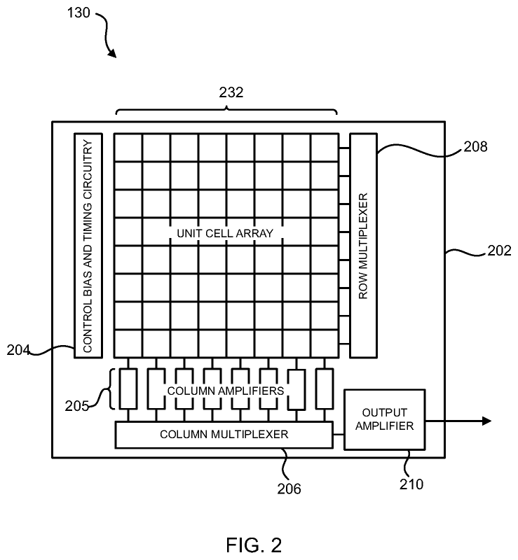

FIG. 2 illustrates a block diagram of image capture component 130 in accordance with an embodiment of the disclosure. In this illustrated embodiment, image capture component 130 is a thermal imager implemented as a focal plane array (FPA) including an array of unit cells 232 (e.g., sensors) and a read out integrated circuit (ROIC) 202. Each unit cell 232 may be provided with an infrared detector (e.g., a microbolometer, indium antimonide (InSb) sensor, multilayer sensor, or other appropriate cooled or uncooled sensor) and associated circuitry to provide image data for a pixel of a captured thermal image frame. In this regard, time-multiplexed electrical signals may be provided by the unit cells 232 to ROIC 202.

For example, in some embodiments, such sensors may be cooled sensors, high operating temperature (HOT) cooled sensors (e.g., operating at or near 120 degrees K), or uncooled sensors. In some embodiments, anomalous pixels may be more likely in HOT cooled sensors or uncooled sensors than conventional cooled sensors (e.g., InSb sensors). Accordingly, the various embodiments disclosed herein are particularly advantageous in implementations employing HOT cooled sensors or uncooled sensors.

ROIC 202 includes bias generation and timing control circuitry 204, column amplifiers 205, a column multiplexer 206, a row multiplexer 208, and an output amplifier 210. Image frames captured by infrared sensors of the unit cells 232 may be provided by output amplifier 210 to logic device 110 and/or any other appropriate components to perform various processing techniques described herein. Although an 8 by 8 array is shown in FIG. 2, any desired array configuration may be used in other embodiments.

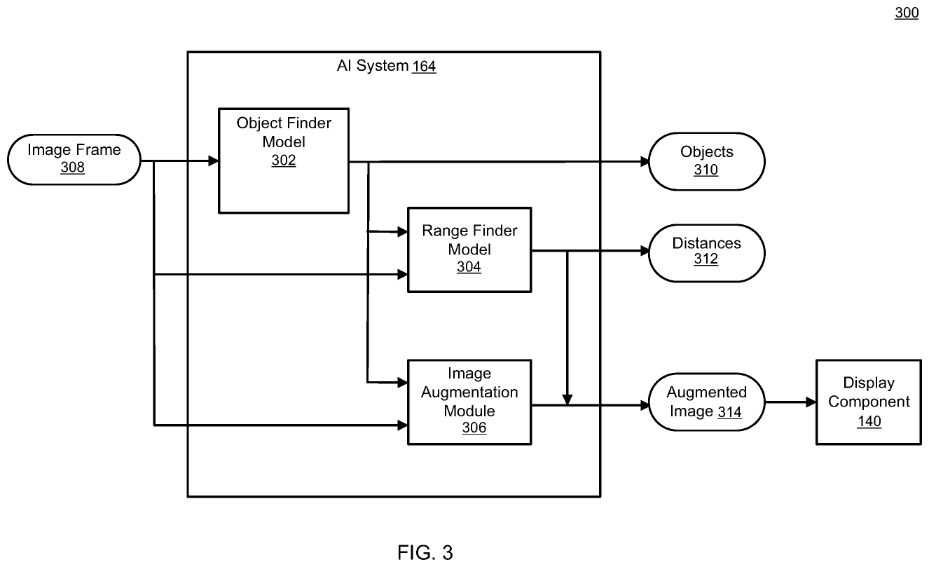

FIG. 3 is a block diagram of an artificial intelligence (AI) system 164, according to some embodiments. AI system 164 may be executed within imaging system 100 discussed in FIG. 1 or be executing on multiple computing devices that are communicatively connected to imaging system 100. AI system 164 may include an object finder model 302, a range finder model 304, and an image augmentation module 306.

Object finder model 302 may be or include one or more neural network models conducive to processing image frames 308 and trained to identify objects 310 included in the image frames 308. Object finder model 302 may receive image frames 308 taken by image capture component 130 and identify objects 310 in image frames 308. There may be multiple objects 310 in each image frame 308.

In some embodiments, one of the neural network models in object finder model 302 may be a convolutional neural network that includes a combination of one or more convolutional layers, pooling layers, filtering layers, dense layers, and/or a classification layer. Each image frame 308 may pass through these layers of the convolutional neural network model that act upon the image frame 308. After the image frame 308 is passed through multiple layers of the neural network model, the classification layer may classify the objects 310 identified by the neural network model with various degrees of probabilities. A classification with the highest probability for each object in the image frame 308 may be a classification for an object in objects 310. Some example types of objects 310 that object finder model 302 may classify may be a person, car, building, tree, cell tower, etc.

In some instances, the one or more neural network models in object finder model 302 may be unable to identify the type of an object. In this case, object finder model 302 may include an object in objects 310 with a type that is unknown or undefined.

Range finder model 304 may receive objects 310 and the corresponding image frame 308 and identify the distance of each object in objects 310 from imaging system 100 and/or the image capture component 130. For example, range finder model 304 may identify the size of each object in image frame 308 based on the number of pixels on target. Based on the size of each object, range finder model 304 may estimate the distance of the object from the imaging system 100 or image capture component 130.

In some embodiments, range finder model 304 may also include one or more neural network models. The one or more neural network models may be the same or different neural network models as in object finder model 302. The one or more neural network models in range finder model 304 may be trained on a training dataset. The training dataset may include image frames with objects of various types and pixel sizes and corresponding labels indicating distances from where the image frames were captured. Once trained, range finder model 304 may be uploaded to AI system 164 in imaging system 100 to receive objects 310 and image frames 308 and estimate distances 312 of objects 310 from imaging system 100 or image capture component 130 based on the types of identified objects 310 and the corresponding size of the objects in image frames 308.

In some instances, range finder model 304 may be trained using various fields of view (FOVs) to determine the distances 312 of objects 310 based on their respective sizes. Further, the FOVs may be set using a hyperparameter associated with range finder model 304, which may cause the range finder model 304 to be able to identify distances 312 for objects 310 from image frames 308 having different FOVs.

In some instances, range finder model 304 may be unable to identify a distance in distances 312 of an object in objects 310. In this case, range finder model 304 may include a default or an undefined value for the distance that indicates that the distance could not be identified. An object with a default or undefined value may be tagged for range finding using another component or device, such as a range finder.

In some instances, range finder model 304 may also include probabilities that are associated with distances 312. The probabilities may identify a certainty or confidence with which range finder model 304 identified distances for corresponding objects 310. Probabilities below a predefined probability threshold may indicate that a distance is unknown or undefined. The probabilities may be determined from a classification layer of the neural network model in range finder model 304. For example, the classification layer may classify the distances to objects 310 with various degrees of probabilities. A classification with the highest probability for the distance of each object may correspond to the distance.

In some instances, image augmentation module 306 may augment objects 310 in image frames 308 to generate an augmented image 314. For example, image augmentation module 306 may augment objects 310 by highlighting objects 310, encircling or drawing a box around objects 310, and the like. In some instances, the color of the highlight, circle, box, etc., may correspond to a confidence or probability with which range finder model 304 identified distances 312 of objects 310. For example, an object in objects 310 for which range finder model 304 identified a distance in distances 312 with a probability higher than a predefined high threshold may be highlighted in green. In another example, an object in objects 310 for which range finder model 304 identified a distance in distances 312 with a probability higher than a predefined medium threshold but lower than the high threshold may be highlighted in yellow. In yet another example, an object in objects 310 for which range finder model 304 identified a distance in distances 312 with a probability lower than a predefined low threshold or an object for which range finder model 304 was unable to identify a distance in distances 312 may be highlighted in red.

In other instances, the color of the highlight, circle, box, etc., may correspond to the type of an object. For example, augmented image 314 may augment an object in objects 310 that is a vehicle with an orange color, an object in objects 310 that is a human with a green color, an object in objects 310 that is a cell tower with a blue color, and an object in objects 310 that is unknown with a red color.

Display component 140 may receive augmented images 314 and display the augmented images 314. Display component 140 may be operable to display augmented images 314 as three-dimensional (3D) images. The 3D rendering of augmented image 314 may be achieved by presenting unique augmented images 314 on display component 140 from slightly different perspectives. The perspectives may be obtained from the imager device that has independent display eyepieces (e.g., bi-ocular), so that the 3D imagery could be presented on display component 140. Image frames 308 that correspond to videos or streams from each eyepiece in the bi-ocular device may then be processed by AI system 164 and displayed as 3D augmented images 314 by display component 140.

In some instances, a user operating control component 150, discussed in FIG. 1 (not shown), may activate a 3D screen causing display component 140 to display augmented image 314 in 3D. In some instances, display component 140 may generate the 3D scene by bringing highlighted objects 310 closer and offsetting the highlighted objects 310 by a number of display elements in each eye to create depth. In some instances, control component 150 may receive input to select or deselect one or more highlighted objects 310 in the displayed augmented image 314. The objects 310 that are deselected may be excluded from the 3D rendering of augmented image 314. In some instances, control component 150 may also receive distances for one or more objects in objects 310. For example, a user may use a range finder to determine a distance for an object in objects 310 with an unknown distance (e.g., for an object for which range finder model 304 was unable to determine a distance) and submit the distance to control component 150. Control component 150 may also receive instructions to select the object in augmented image 314 and associate the object with the submitted distance. In some instances, control component 150 may also overwrite one or more distances 312 for one or more objects 310 with distances that are received from the user via control component 150.

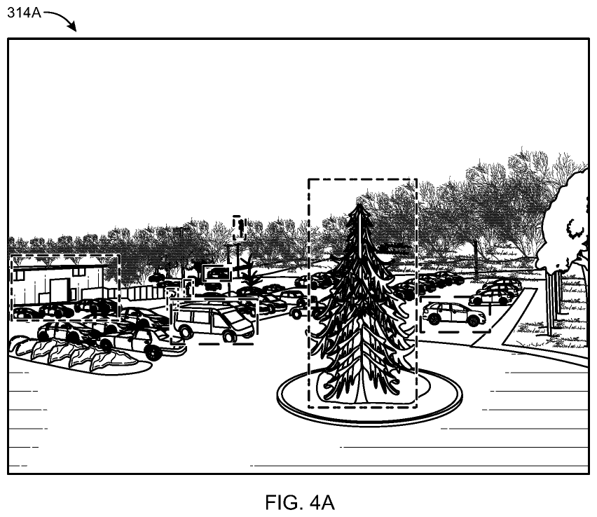

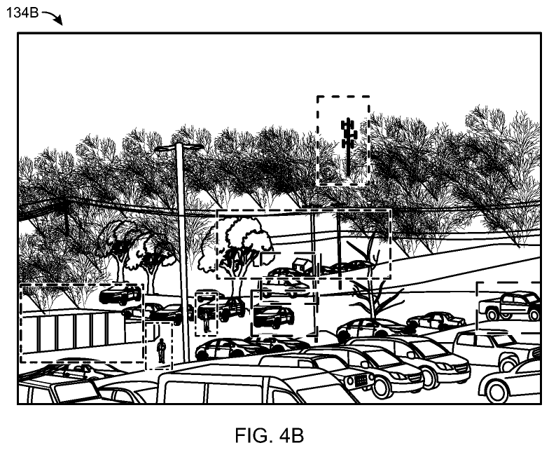

FIGS. 4A-B illustrate example augmented images with objects, in accordance with an embodiment of the disclosure. FIG. 4A illustrates augmented image 314A with eight objects 310 that were detected by AI system 164. Moreover, augmented image 314A includes highlighting that corresponds to different object types, such that objects 310 identified as humans are highlighted in green, a cell tower is highlighted in blue, cars are highlighted in red, and unknown objects 310 are highlighted in red. FIG. 4B illustrates augmented image 314B with eight objects 310 that were detected by AI system 164. Moreover, augmented image 314B includes highlighting that corresponds to different object types, such that objects 310 identified as humans are highlighted in green, a cell tower is highlighted in blue, cars are highlighted in orange, and unknown objects 310 are highlighted in red.

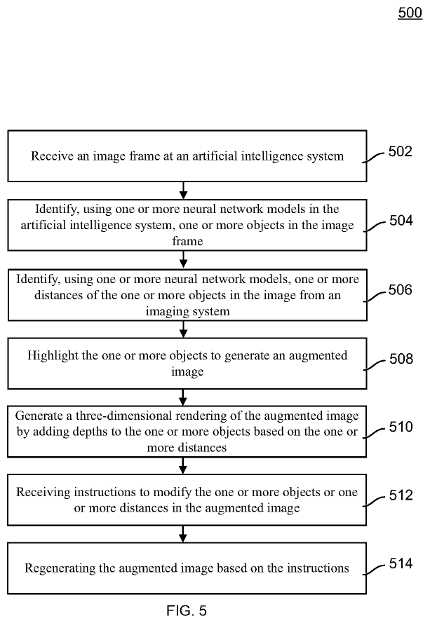

FIG. 5 illustrates a process for generating an augmented image, in accordance with an embodiment of the disclosure. One or more of the operations 502-514 of method 500 may be implemented, at least in part, in the form of executable code stored on non-transitory, tangible, machine-readable media that, when run by one or more processors, may cause the one or more processors to perform one or more of the operations 502-514.

At operation 502, an image frame is received. For example, AI system 164 may receive image frame 308 taken by imaging system 100, such as an imager device, a thermal imager device, and the like, which may also have two independent displays. Image frame 308 may be part of a video or a stream taken by the imaging system.

At operation 504, objects in the image frame are identified. For example, one or more neural network models in AI system 164 may identify one or more objects 310 in image frame 308. In some instances, the one or more neural network models may include a convolutional neural network model for classifying one or more objects 310 in image frame 308 according to different object types.

At operation 506, distances of the objects in the image frame are identified. For example, the one or more models in AI system 164 may identify distances 312 of objects 310, e.g., one distance for one object, in image frame 308 from imaging system 100. The distances 312 may be based on the sizes of the one or more objects 310 in image frame 308.

At operation 508, objects in the image frame are augmented to generate an augmented image. For example, AI system 164 may highlight, encircle, box in, etc., the one or more identified objects 310 to generate augmented image 314. In some instances, the colors of the highlight for different objects 310 may correspond to types of objects 310. In other instances, the colors of the highlights for different objects 310 may correspond to a confidence in the distances 312 associated with objects 310.

At operation 510, a three-dimensional rendering of the augmented image is generated. For example, display component 140 may render augmented image 314 that includes highlighted objects as a 3D image. Further, each object in objects 310 in the 3D rendering of augmented image 314 may appear closer or further based on a corresponding distance in distances 312.

At operation 512, instructions to modify the one or more objects are received. For example, control component 150 may receive instructions to select or deselect an object in objects 310. A deselected object may not be rendered based on the corresponding distance in the 3D representation of augmented image 314. In another example, control component 150 may receive instructions to associate a distance with an object. For example, when AI system 164 is unable to identify a distance of an object in objects 310, control component 150 may receive instructions that include the distance.

At operation 514, a three-dimensional representation of the image is regenerated. For example, display component 140 may regenerate a 3D rendering of augmented image 314. The regenerated 3D rendering of the augmented image may be based on instructions received in operation 512. For example, a deselected object in objects 310 may not be included in the 3D rendering of augmented image 314. In another example, an object that was associated with a distance in operation 512 may be displayed in the 3D rendering of the augmented image 314 based on the distance.

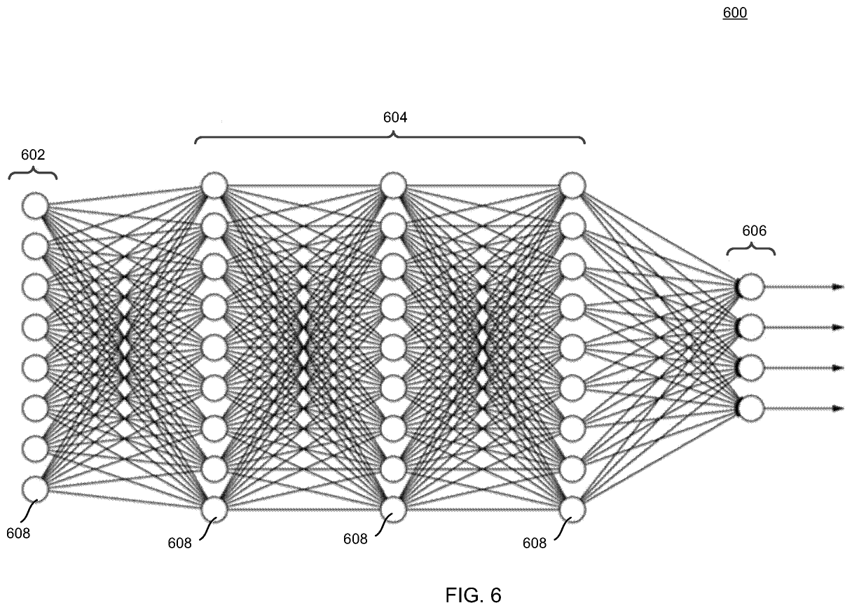

FIG. 6 is a simplified diagram illustrating the neural network structure that may be implemented in one or more neural network models in AI system 164, according to some embodiments. A neural network model may include a perceptron neural network, a feed forward neural network, a multilayer perceptron network, a convolutional neural network, a radial basis functional neural network, a recurrent neural network, an LSTM (Long Short-Term Memory) network and the like.

The neural network models may comprise neural network architecture. The example neural network architecture may comprise an input layer 602, one or more hidden layers 604 and an output layer 606. The neural network models may be built as a collection of connected units or nodes, referred to as neurons 608. Each layer 602, 604, or 606 may comprise the same or different number of neurons or nodes 608, with neurons between layers being interconnected according to a specific topology. Each neuron 608 may be associated with an adjustable weight. The neurons 1208 may be aggregated into layers 602, 604, 606 such that different layers may perform different transformations on the respective input to generate a transformed output, which is an input for the subsequent layer. Further, different layers in neural network models may be combined into their own neural network models, such that an output layer of one neural network model, is an input into the next neural network model, until a final output layer 606 is reached. The number of layers 604 and neurons 608 within each layer may vary depending on complexity and type of the neural network model.

Input layer 602 receives input data. The input data may be image data including image frames, thermal image frames, and the like. In some instances, input data may be image frames received from an image capture component 130 discussed in FIG. 1. The image frames may be thermal image frames. The number of nodes (neurons) in the input layer 602 may be determined by the dimensionality of the input data (e.g., a three-dimensional array having height, width, and color channels).

The hidden layers 604 are intermediate layers located between the input and output layers 602, 606 of the neural network models. Although three hidden layers 64 are shown, there may be any number of hidden layers in the neural network model. Generally, neural network models with more layers are more computationally intensive and/or accurate, while neural network models with fewer hidden layers are less computationally intensive and/or accurate. Hidden layers 604 may extract and transform the input data through series of weighted computations and activation functions associated with individual neurons.

For example, the neural network models may receive image frames at input layer 602 and generate output of output layer 606, which may be objects 310 and/or distances 312 of objects 310. To perform the transformation, each neuron 608 receives input signals (which may be input to the neural network model or an output of the preceding layer), performs a weighted sum of the inputs according to weights assigned to each connection and then applies an activation function associated with the respective neuron 608 to the result. The output of the neuron is passed to the next layer of neurons or serves as the final output of the network. The activation function may be the same or different across different layers 602, 604, 606 and may be different at neurons 608 within each layer. Example activation functions include but are not limited to Sigmoid, hyperbolic tangent, Rectified Linear Unit (ReLU), Leaky ReLU, Softmax, and/or the like. In this way, input data received at the input layer 602 is transformed by hidden layers 604 into different values indicative of data characteristics corresponding to a task that the neural network models have been trained to perform.

In some embodiments, hidden layers 604 may further be combined in layers and blocks. In a non-limiting embodiment, hidden layers 604 may be combined into one or more of convolutional layer(s), pooling layer(s), flattening layer(s), and/or fully connected layer(s). A convolutional layer(s) may detect features in an image frame using one or more filters. As an image frame passes through the filters in the convolution layer(s), convolutional layer(s) generate feature maps. Each filter may identify a specific feature in the image that corresponds to a feature map. A pooling layer may reduce the dimensions, e.g., height and width of the feature maps while retaining essential features in the feature maps. In some embodiments, convolutional layer(s) and pooling layer(s) may be stacked or interspersed with each other creating a deep neural network that may learn complex features. A flattening layer may follow one or more convolutional layer(s) and pooling layer(s). A flattening layer may flatten the feature maps that are the output of the preceding convolution layer or pooling layer to generate a one-dimensional vector. A fully connected layer includes one or more hidden layers 604 where neuron 608 of a preceding layer is connected to each neural in the next layer (e.g., as shown in FIG. 6). A fully connected layer may receive the one-dimensional vector and combine different features identified from the convolutional layer(s), pooling layer(s) and flattening layer(s) to identify one or more objects in the image frame.

The output layer 606 is the final layer of the neural network structure. It produces the network's output or prediction based on the computations performed in the preceding layers (e.g., 602, 604). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class. In some embodiments, each specific class may correspond to objects in the image frame. In some instances, output layer 606 may use a softmax function that determines probabilities that objects 310 in the image frame correspond to different classes or probabilities of the distances 312 of objects 310.

Neural network models may also be implemented by hardware, software, and/or a combination thereof. For example, neural network models may comprise a specific neural network structure implemented and run on various hardware platforms, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware may be used to implement the neural network structure is specifically configured based on factors such as the complexity of the neural network, the scale of the tasks (e.g., training time, input data scale, size of training dataset, etc.), and the desired performance.

Neural network models may be trained by iteratively updating the underlying weights of the neurons 608, etc., bias parameters and/or coefficients in the activation functions associated with neurons 608. The weights may be updated based on a loss function, such as a mean squared estimation error (MSEE), cross-entropy loss, log-loss, and the like. For example, during training, the training data such as few-shot examples, APIs, queries, etc., are fed into neural network model over thousands of iterations. The training data flows through the network's layers 602, 604, 606, with each layer performing computations based on its weights, biases, and activation functions until the output layer 606 produces the output.

The training data may be labeled with an expected output (e.g., a “ground-truth” and a corresponding ground truth label). For example, images frames in the training dataset may be labeled with objects included in the corresponding image frames. The output generated by the output layer 606, e.g., the classifications of the objects in the image frames are compared to the expected output, e.g., the labels in the image frames from the training data to compute a loss function that measures the discrepancy between the predicted output and the expected output. In another example, images frames in the training dataset may be labeled with distances of objects included in the corresponding image frames that are based on the objects' pixel size. The output generated by the output layer 606, e.g., the classifications of the distances of objects in the image frames are compared to the expected output, e.g., the labels in the image frames from the training data to compute a loss function that measures the discrepancy between the predicted output and the expected output. In some embodiments, the negative gradient of the loss function may be computed with respect to the weights of each layer individually. This negative gradient is computed one layer at a time, iteratively backward from the last layer 606 to the input layer 602 of the neural network models. These gradients quantify the sensitivity of the network's output to changes in the parameters. The chain rule of calculus is applied to efficiently calculate these gradients by propagating the gradients backward (in a back propagation network) from the output layer 606 to the input layer 602.

Parameters of the neural network are updated backwardly from the last layer to the input layer (backpropagating) based on the computed negative gradient using an optimization algorithm to minimize the loss. The backpropagation from the last layer 606 to the input layer 602 may be conducted for a number of training samples in a number of iterative training epochs. In this way, parameters of the neural network models may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. In a multiple neural network embodiment, the neural network models may be trained separately and then combined together and trained as a single neural network model.

Neural network parameters may be trained over multiple stages. For example, initial training (e.g., pre-training) may be performed on one set of training data, and then an additional training stage (e.g., fine-tuning) may be performed using a different set of training data, such as machine-readable code in one or more programming languages. In some embodiments, all, or a portion of parameters of one or more neural-network models being used together may be frozen, such that the “frozen” parameters are not updated during that training phase. This may allow, for example, a smaller subset of the parameters to be trained without the computing cost of updating all the parameters.

Therefore, the training process transforms the neural network into an “updated” trained neural network with updated parameters such as weights, activation functions, and biases. The trained neural network thus improves neural network technology for generating executable queries that may be executed by a database, another application interface, and the like to retrieve data.

Once training is complete, the trained neural network models may enter an inference stage where neural network models may be incorporated into AI system 164 and used to generate responses to various prompts.

In various embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) adapted to communicate with other communication networks, such as the Internet. As such, in various embodiments, the imaging system 100 may be associated with a particular network link such as for example a URL (Uniform Resource Locator), an IP (Internet Protocol) address, and/or a mobile phone number.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
receiving an image frame;
identifying, using one or more neural network models, one or more objects in the image frame;
identifying, using the one or more neural network models, one or more distances corresponding to the one or more objects based on corresponding one or more sizes of the one or more objects in the image frame;
generating an augmented image based on the one or more objects and/or the one or more distances; and
displaying a three-dimensional rendering of the augmented image.

2. The method of claim 1, wherein the image frame is generated by a bi-ocular thermal imager and the image frame includes a thermal image.

3. The method of claim 1, wherein the augmented image includes highlights that encircle the one or more objects.

4. The method of claim 3, wherein colors of the highlights correspond to types of the one or more objects.

5. The method of claim 3, wherein colors of the highlights correspond to confidences for identifying the one or more distances for the corresponding one or more objects.

6. The method of claim 1, wherein the displayed three-dimensional rendering of the augmented image displays the one or more objects at depths based on the one or more distances.

7. The method of claim 1, further comprising:
determining an object in the one or more objects for which the one or more neural network models failed to identify a distance in the one or more distances;
receiving input from a range finder that corresponds to the distance; and
regenerating the three-dimensional representation of the augmented image to include the object at a depth based on the received distance.

8. The method of claim 1, further comprising:
receiving input deselecting an object from the displayed three-dimensional rendering of the augmented image; and
regenerating the three-dimensional rendering of the augmented image without the object.

9. A system comprising:
a logic device configured to execute an artificial intelligence system comprising one or more neural network models and configured to:
receive an image frame;
identify, using one or more neural network models, one or more objects in the image frame;
identify, using the one or more neural network models, one or more distances corresponding to the one or more objects based on corresponding one or more sizes of the one or more objects in the image frame;
generate an augmented image based on the one or more objects and/or the one or more distances; and
display a three-dimensional rendering of the augmented image.

10. The system of claim 9, wherein the image frame is generated by a thermal imager.

11. The system of claim 9, wherein the augmented image includes highlights that encircle the one or more objects.

12. The system of claim 11, wherein colors of the highlights correspond to types of the one or more objects.

13. The system of claim 11, wherein colors of the highlights correspond to confidences for identifying the one or more distances for the corresponding one or more objects.

14. The system of claim 9, wherein the displayed rendering of the three-dimensional augmented image displays depths of the one or more objects based on the one or more distances.

15. The system of claim 9, further comprising:
determining an object in the one or more objects for which the one or more neural network models failed to identify a distance in the one or more distances;
receiving input that corresponds to the distance; and
regenerating the three-dimensional rendering of the augmented image to include the object at a depth based on the received distance.

16. The system of claim 9, further comprising:
receiving input deselecting an object from the three-dimensional rendering of the augmented image; and
regenerating the three-dimensional rendering of the augmented image without the object.

17. A non-transitory computer readable medium having instructions stored thereon, that when executed by a processor cause the processor to perform operations, the operations comprising:
receiving an image frame;
identifying, using one or more neural network models, one or more objects in the image frame;
identifying, using the one or more neural network models, one or more distances corresponding to the one or more objects based on corresponding one or more sizes of the one or more objects in the image frame;
generating an augmented image based on the one or more objects and/or the one or more distances; and
displaying a three-dimensional representation of the augmented image.

18. The non-transitory computer readable medium of claim 17, wherein the augmented image includes highlights that encircle the one or more objects.

19. The non-transitory computer readable of claim 18, wherein colors of the highlights correspond to types of the one or more objects or to confidences for identifying the one or more distances for the corresponding one or more objects.

20. The non-transitory computer readable of claim 17, wherein the displayed three-dimensional augmented image displays depths of the one or more objects based on the one or more distances.
